(19) United States
(12) Patent Application Publication
(10) Pub. No.: US 2009/0217527 A1
(43) Pub. Date: Sep. 3, 2009

(54) HEAT EXCHANGER CORE TUBE FOR INCREASED CORE THICKNESS

(75) Inventor: Timothy J. Schrader, Irwin, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: Liebert Corporation, Columbus, OH (US)

(21) Appl. No.: 12/435,566

(22) Filed: May 5, 2009

Related U.S. Application Data
(62) Division of application No. 11/751,149, filed on May 21, 2007.

(51) Int. Cl. B23P 15/26

(52) U.S. Cl. 29/890.053

(57) ABSTRACT

A heat exchanger core tube having a body with at least one internal fluid passage and having at least one end adapted such that an effective height results that is less than or equal to the inside diameter of a manifold and can allow the body of the core tube to have a height greater than the inside diameter of the manifold. The at least one adapted end may comprise an adapter and may be twisted such that the longitudinal axis of a core tube remains substantially normal to the longitudinal axis of the manifold and wherein the end of the core tube is angled less than 90 degrees with respect to the tube body.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The present disclosure relates generally to precision cooling systems for high-density heat loads, and, more particularly, to a heat exchanger having increased core thickness.

2. Description of the Related Art

Electronic equipment is oftentimes housed in a critical or controlled space, such as a computer room or telecommunications room, and usually requires precise, reliable control of temperature, humidity and airflow. Excessive heat or humidity can damage or impair the operation of computer systems and other electronic or electrical components. Components may often be positioned in close proximity to one another in a high density arrangement for a number of reasons, such as increased performance or reduced cable costs and routing complexity. However, increases in the power and density of computer and electronic equipment usually results in an increase in heat generation, thereby requiring more cooling or heat transfer to avoid damaging the equipment or reducing performance.

For reasons such as these, precision cooling systems are designed and employed in high heat density applications. Often, such cooling systems employ air-to-fluid heat exchangers to remove heat from the air near heat-producing components. It is known that the heat transfer capabilities of air-to-fluid heat exchanger may be increased by, for example, increasing the heat transfer surface area, increasing the fluid flow rate, or increasing the air flow rate. Increasing the heat transfer surface area may be restricted by the space available for the heat exchanger system. This may be particularly true in high density racks or enclosures where space is at a premium.

This disclosure teaches an improved heat exchanger having increased heat transfer surface area for a given occupied space, and cooling systems using such heat exchanger.

### BRIEF SUMMARY OF THE INVENTION

A heat exchanger core tube is disclosed for transferring heat from an environment to a fluid, for example. The core tube may have a body and at least one internal fluid passage such that a working fluid may pass through the core tube. Further, the core tube may have first and second ends, wherein at least one end may be adapted,. such as by twisting or reducing, to couple to a heat exchanger manifold. A twisted end may be coupled to a manifold such that the longitudinal axis of a core tube remains substantially normal to the longitudinal axis of the manifold and wherein the end of the core tube is angled less than 90 degrees with respect to the tube body. The core tube may also have a second twisted end and either twisted end may comprise, for example, a twisted portion of the body of the core tube or an adapter coupled to the end of the body. In various embodiments of the disclosed core tube, the tube may, for example, have a height greater than the inside diameter of a manifold to which the tube may be coupled. The tube may be hollow or may comprise one or more micro-channels. A core tube may comprise all of these features, parts or any combination thereof, or none at all.

Further disclosed is a heat exchanger, for example, for transferring heat from an environment to a fluid. The heat exchanger may include a manifold and may have one or more core tubes, such as those mentioned above, coupled to the manifold. Each of the one or more core tubes coupled to the manifold may be of the same embodiment, of separate embodiments or any combination thereof. A method is also disclosed, such as for increasing the heat transfer capability of a heat exchanger. The method may include providing a heat exchanger manifold and a core tube, such as for example a core tube described above, and coupling one end of the core tube to the manifold such that the longitudinal axis of a core tube remains substantially normal to the longitudinal axis of the manifold and wherein the end of the core tube is angled less than 90 degrees with respect to the tube body. The method may further include providing more than one core tube, providing more than one manifold, coupling a manifold to one or both ends of a core tube, or any combination thereof. The foregoing summary is not intended to summarize each potential embodiment or every aspect of the present disclosure.

### BRIEF DESCRIPTION OF THE SEVERAL VIEWS OF THE DRAWINGS

The foregoing summary, a preferred embodiment, and other aspects of the subject matter of the present disclosure will be best understood with reference to the following detailed description of specific embodiments when read in conjunction with the accompanying drawings, in which:

FIG. 1 illustrates a perspective view of a heat exchanger core tube utilizing aspects of the present invention.

FIG. 2 illustrates a side view of a heat exchanger core tube in accordance with aspects of the present invention.

FIG. 3 illustrates an end view of a heat exchanger core tube in accordance with aspects of the present invention.

FIG. 4 illustrates a perspective view of a portion of a heat exchanger in accordance with aspects of the present invention.

FIG. 5 illustrates a cross-sectional end view of a portion of a heat exchanger in accordance with aspects of the present invention.

FIG. 6 illustrates a side view of a portion of a heat exchanger core tube having an adapter in accordance with aspects of the present invention.

FIG. 7 illustrates an end view of a heat exchanger core tube having an adapter in accordance with aspects of the present invention.

FIG. 8 illustrates a perspective view of a heat exchanger core tube adapter in accordance with aspects of the present invention.

FIG. 9 illustrates an end view of a heat exchanger core tube adapter in accordance with aspects of the present invention.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Further, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Lastly, the term “couple,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include without limitation integrally forming one functional member with another in a unity fashion. The coupling can occur in any direction, including rotationally.

In one aspect of the inventions disclosed herein, Applicant has created an improved core tube for an air-to-fluid heat exchanger wherein the height of the core tube may be greater than the inside diameter of a heat exchanger manifold. The core tube may be comprised of a body having a heat transfer surface area and at least one internal fluid passage adapted to receive a working fluid. Further, the core tube may have first and second ends, wherein at least one end may be adapted to couple to a heat exchanger manifold. The adapted end may be angled with respect to the rest of the core tube such that the adapted end may be coupled to a manifold having an inside diameter less than the height of the core tube. The core tube may also comprise a male or female adapter to couple the core tube to a manifold having an inside diameter that is less than the height of the core tube. The core tube may be hollow or may comprise one or more micro-channels.

An improved heat exchanger is also disclosed for transferring heat from an environment to a fluid, or vice versa. The heat exchanger may comprise a manifold having an inside flow dimension, such as an inside diameter, and may have one or more core tubes, such as those mentioned above, coupled to the manifold, where one or more core tubes has a height greater than the manifold flow dimension. A method is further disclosed, such as for increasing the heat transfer capability of a heat exchanger. The method may include providing a heat exchanger manifold and a core tube, such as for example a core tube described above having a height greater than can be accepted by the manifold. The method may further include providing more than one core tube, providing more than one manifold, coupling a manifold to one or both ends of a core tube, or any combination thereof

Turning now to the Figures, it will be appreciated that a parallel flow air-to-fluid heat exchanger may be characterized as comprising a fluid inlet manifold, a fluid outlet manifold and a plurality of core tubes there between. The heat exchanger may be constructed in a known manner, so that a working fluid, such as a refrigerant, can flow into the inlet manifold, through the plurality of core tubes and into the outlet manifold. Air is forced to flow across or past the core tubes to transfer heat from the air to the fluid or vice versa. Tube construction may range from round single channel tubes to oval or flat tubes with one or more channels. Furthermore, one or more fins, whether of a type commonly used in the field of heat transfer or otherwise, may be bonded to the exterior of one or more core tubes, or otherwise situated such as to facilitate heat transfer. Typically, the manifolds are round, tubular structures, but may comprise oval or flat tubular structures as well. In any event, the manifolds usually have a maximum flow dimension, such as an inside diameter. To couple the core tubes to the manifold, the outer dimension of the core tube, such as an outer diameter, must be equal to or less than the inside flow diameter of the manifold. Thus, conventional heat exchangers may have maximum core tube heights that are less than the maximum manifold height, resulting in less than optimized core tube heat transfer surface areas.

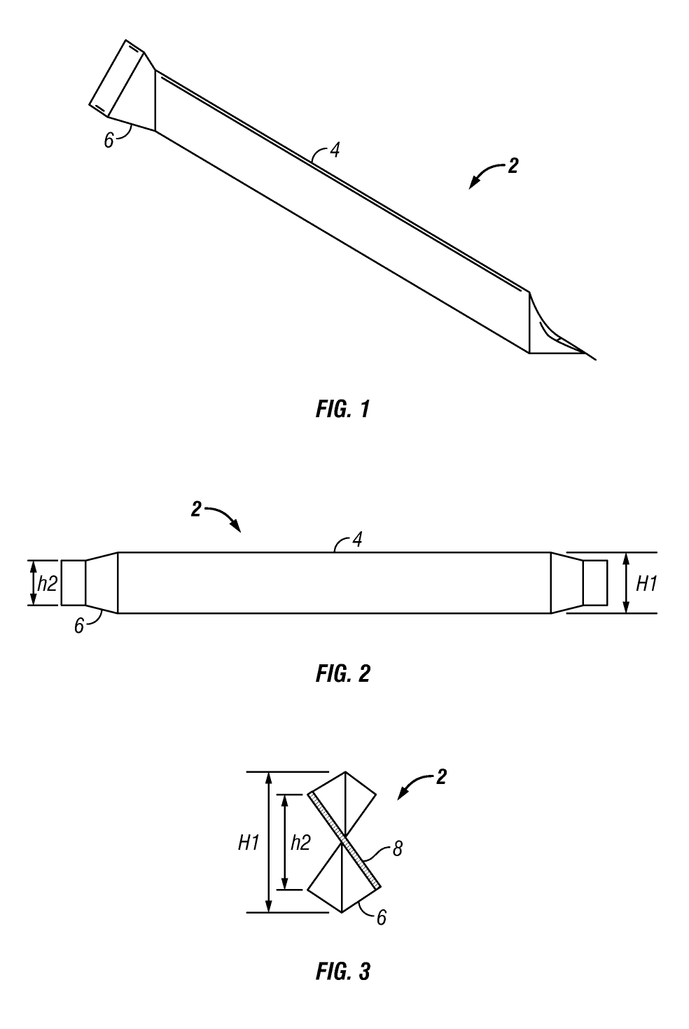

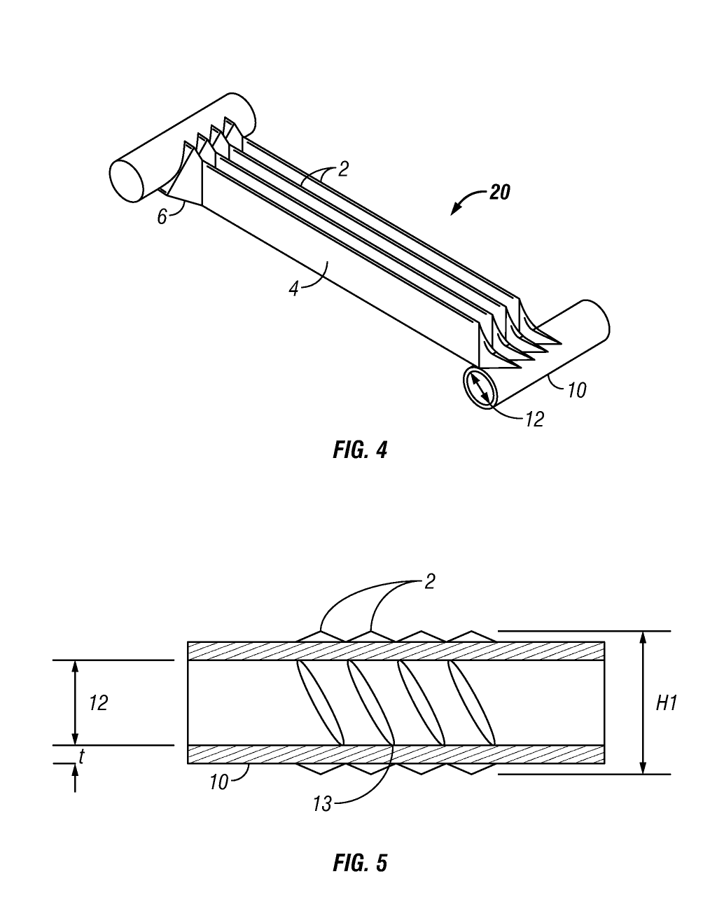

FIG. 1 illustrates a perspective view of a non-round core tube 2 in accordance with aspects of the present invention. Core tube 2 may comprise a body portion 4 and end portion 6. FIG. 2 illustrates a side view and FIG. 3 illustrates an end view of the core tube 2 illustrated in FIG. 1. These Figures will be described in conjunction with each other and, as will be explained more fully below, these embodiments may be referred to as “twisted end” embodiments. As shown in FIGS. 1-3, the body portion 4 has at least one internal fluid passage such that a working fluid (not shown), such as, for example, a single phase refrigerant or a multiple phase refrigerant, or other working fluids known in the art of heat transfer, may pass through the core tube 2. The core tube 2 may be produced by known manufacturing techniques and composed of copper, aluminum, steel, alloys thereof, or any other suitable material in accordance with the demands of a particular application. As shown in FIG. 2, the body portion 4 may have a maximum outer dimension, such as height Hi, and may be hollow or may include, for example, a plurality of micro-channels 8 (FIG. 3) configured to allow a working fluid to pass through the core tube 2. The core tube 2 illustrated in FIGS. 1-3 may be described as a “flat” tube having a height and a thickness and a surface area. In other embodiments of the present invention, the core tube 2 may have a circular, elliptical, oval or any other cross section required or preferred for a particular cooling application.

FIGS. 4-5 illustrate portions of a heat exchanger 20 made in accordance with aspects of the present invention. As shown, manifold 10 is a tubular manifold having a maximum flow dimension represented by inside diameter 12. It will be appreciated to fully communicate the flow area of the manifold 10 to a core tube 2, the flow dimensions of the core tube must be less than or equal to the flow dimension of the manifold 10. For example, it is common for the outer maximum dimension of the core tube 2 to be less than or equal to the inside diameter of the manifold 10. In the heat exchanger 20 illustrated in FIGS. 4-5, the maximum dimension of the core tube 2 is greater than the maximum flow dimension of the manifold 10 and preferably equal to or greater than the maximum outside dimension of the manifold 10.

To achieve this improved result, the core tube 2 may have one or more end portions 6 that are angled or twisted with respect to the body portion 4. The body portion 4 of a core tube 2 may have a height Hi greater than the inside diameter 12 of a manifold 10. In such an embodiment, the twisted ends 6 of the core tube 2 may be coupled to the manifold 10 at an angle such that the longitudinal axis of a core tube remains substantially normal to the longitudinal axis of the manifold and wherein the end of the core tube is angled less than 90 degrees with respect to the tube body. Further, considering the wall thickness t of the manifold 10, the effective height h2 (See FIG. 2) of the twisted end 6 may be less than or equal to the inside diameter 12 of the manifold 10. A twisted end 6 may for example be inserted into the side of a manifold 10 thru an opening or slit 13 such that the twisted end 6 may fit within the inside diameter 12 of a manifold 10 and wherein the body 4 of a core tube 2 may retain a height H greater than the inside diameter of the manifold 10. Furthermore, improved fluid flow conditions may exist within a manifold 10 for reasons such as decreased flow resistance across twisted ends 6.

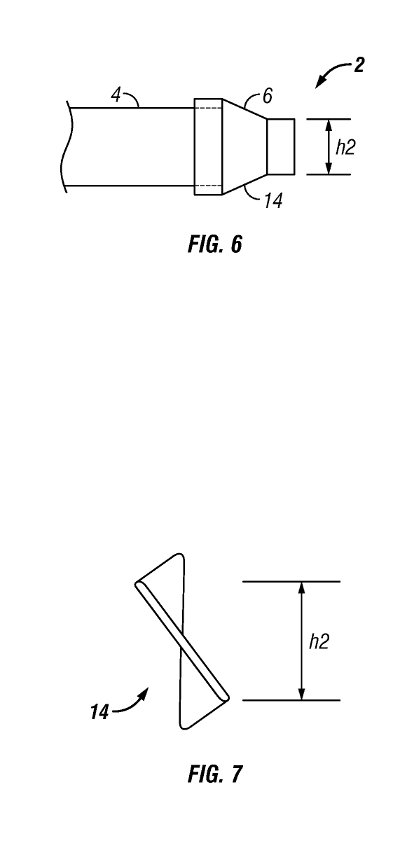

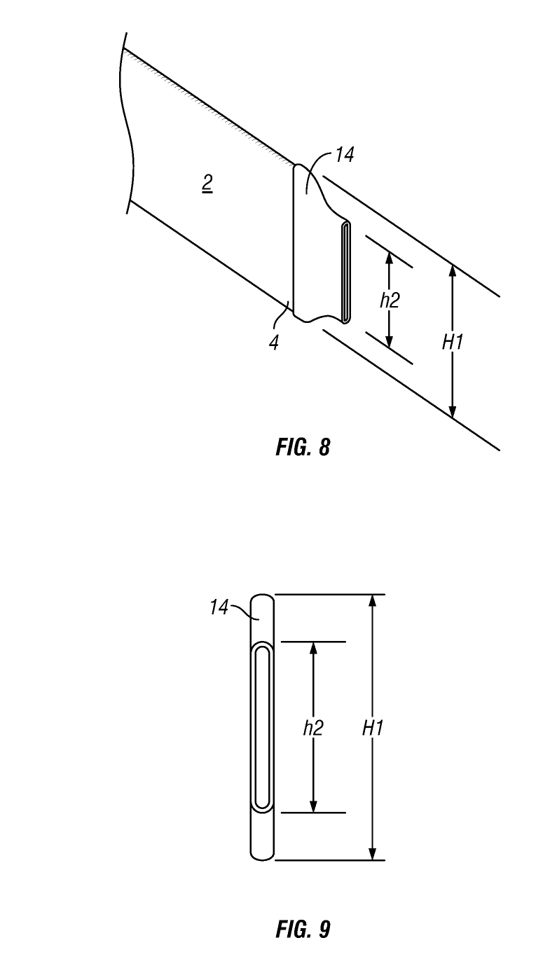

FIG. 6 illustrates a side view of a portion of a heat exchanger core tube having an adapter in accordance with aspects of the present invention. FIG. 7 illustrates an end view of a heat exchanger core tube having an adapter in accordance with aspects of the present invention. These Figures will be described in conjunction with each other. In a further embodiment of the present invention, a twisted end 6 of a core tube 2 may comprise an adapter 14, wherein for example one end of the adapter 14 may be coupled to one end of a body 4 of a core tube 2. An opposite end of the adapter 14 may be twisted such that an effective height h2 results, wherein the effective height may be less than or equal to the inside diameter of a manifold 10 to which the adapter 14 may be coupled. While FIG. 6 illustrates a female adapter, it will be appreciated that a male adapter that is inserted inside of a core tube 2 is also contemplated. Such adapters may be coupled to core tubes 2 having a variety of cross-sections in accordance with a particular application, including but not limited to circular, elliptical, or that of a thin tube as in FIG. 1.

FIG. 8 illustrates a perspective view of a heat exchanger core tube adapter in accordance with aspects of the present invention. FIG. 9 illustrates an end view of the adapter in FIG. 8. These Figures will be described in conjunction with each other. In a further embodiment of the present invention, a core tube 2 may comprise an adapter 14, wherein for example one end of the adapter 14 may be coupled to one end of a body 4 of a core tube 2. An opposite end of the adapter 14 may be reduced, or modified in arrangement such that an effective height h2 results, wherein the effective height may be less than or equal to the inside diameter of a manifold 10 to which the adapter 14 may be coupled. It will be appreciated that the openings 13 (FIG. 5) in the side of a manifold may be vertically oriented or otherwise configured to couple to a core tube having a cross-section in accordance with a particular application. While FIGS. 8 and 9 illustrate a female adapter, it will be appreciated that a male adapter that is inserted inside of a core tube 2 is also contemplated. Such adapters may be coupled to core tubes 2 having a variety of cross-sections in accordance with a particular application and may themselves have a variety of cross-sections, including but not limited to circular, elliptical, or that of a thin tube as in FIG. 1. It will be further appreciated that the cross-sections of opposite ends of an adapter 14 may be similar or they may differ in accordance with a particular application.

Various embodiments of Applicant's invention may, for example, include manifolds 10 having outside diameters of 0.71, 1.18, or 1.56 inches and wall thicknesses of 0.060 inches. In such embodiments, for example, the end 6 of a core tube 2 may be twisted or reduced such that the effective height h2 may be less than or equal to the inside diameters of the manifolds, or 0.59, 1.06, or 1.44 inches, respectively. For instance, this may allow the end 6 of the core tube 2 to be coupled to a manifold 10 while the height H may remain equal to or greater than the inside diameter of a manifold 10. One of ordinary skill in the art will realize that a relationship may exist such that a pressure difference may occur when working fluid flows between a core tube 2 and a manifold 10. Further, the relationship may have some bearing on the extent to which a core tube diameter or height H exceeds the inside diameter of a manifold 10, such as for example to limit a height H or diameter to between 1 and 1.5 times greater than the inside diameter of a manifold 10.

Other and further embodiments utilizing one or more aspects of the inventions described above can be devised without departing from the spirit of Applicant's invention. For example, a core tube 2 may include only one twisted end 6 coupled to a manifold 10 while the other end maintains the cross-section of the body 4 or another shape in accordance with a particular application. Further, the various methods and embodiments of the core tubes 2 can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to fully protect all such modifications and improvements that come within the scope or range of equivalent of the following claims.

1. (canceled)

2. (canceled)

3. (canceled)

4. (canceled)

5. (canceled)

6. (canceled)

7. (canceled)

8. (canceled)

9. A method of increasing the heat transfer capability of a heat exchanger, comprising:
providing at least one manifold having a longitudinal axis;
providing at least one core tube having a first end, a second end, a longitudinal axis and a body with at least one internal fluid passage;
twisting at least one end of the at least one core tube; and
coupling the at least one twisted end to the manifold so that the longitudinal axis of the core tube remains substantially normal to the longitudinal axis of the manifold and wherein the at least one twisted end is angled less than 90 degrees with respect to the tube body.

10. The method of claim 9, wherein the at least one core tube has a height greater than an inside diameter of the manifold to which the core tube is coupled.

11. The method of claim 9, wherein twisting at least one end of the at least one core tube comprises coupling an adapter to the at least one twisted end of the core tube.

12. A method of increasing the heat transfer capability of a heat exchanger, comprising:
providing at least one manifold;
providing at least one core tube having a first end, a second end, and a body with at least one internal fluid passage;
reducing the effective height of at least one end of the at least one core tube; and
coupling the reduced end to the manifold.

13. The method of claim 12, wherein the at least one core tube has a height greater than an inside diameter of the manifold to which the core tube is coupled.

14. The method of claim 12, wherein reducing the effective height of at least one end of the at least one core tube comprises coupling an adapter to at least one end of the core tube.

15. The method of claim 9, further comprising:
providing a plurality of core tubes having first and second ends;
twisting at least one end of each core tube; and
coupling the at least one twisted end of each core tube to the manifold.

16. The method of claim 15, further comprising:
providing a plurality of manifolds;
twisting each end of each of the plurality of core tubes; and
coupling each end of each core tube to a manifold.

17. The method of claim 12, further comprising:
providing a plurality of core tubes having first and second ends;
reducing the effective height of at least one end of each core tube; and
coupling the at least one reduced end of each core tube to the manifold.

18. The method of claim 17, further comprising:
providing a plurality of manifolds;
reducing the effective height of each end of each of the plurality of core tubes; and
coupling each end of each core tube to a manifold.
